(19) United States
(12) Patent Application Publication
(10) Pub. No.: US 2007/0133428 A1
(43) Pub. Date: Jun. 14, 2007

(54) System and method for providing dynamic QoS based upon group profiles

(76) Inventors: Carolyn Taylor, Chicago Heights, IL (US); Dragan M. Boscovic, South Barrington, IL (US); Thomas C. Hill, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 11/301,558

(22) Filed: Dec. 13, 2005

(51) Int. Cl. H04J 1/16

(52) U.S. Cl. 370/252; 370/338

(57) ABSTRACT

A usage pattern is determined for at least one member (102 or 104) of a group. A Quality-of-Service (QoS) level (114) is determined for the group and is based upon the usage pattern of the at least one member (102 or 104) of the group. The QoS level (114) is dynamically modified based upon changes in the usage pattern of the at least one member of the group (102 or 104).

### FIELD OF THE INVENTION

The field of the invention relates to routing communications through networks and, more specifically, to providing Quality-of-Service (QoS) profiles for members of a group.

### BACKGROUND OF THE INVENTION

Various types of networks and combinations of networks are used in current communication systems. For example, wireless networks, such as cellular networks, transmit voice calls between users. Packet data networks also exist and these types of networks transmit packets of information between users. Alternate networks such as Wireless Local Area Networks (WLANs) that employ certain protocols (e.g., the Bluetooth protocol) also are used to transmit information. Oftentimes, these networks are interconnected such that communications are transmitted across various networks in order to reach a final destination.

In many of these types of networks, users are assigned to user groups and these user groups frequently have an associated profile. The profile may indicate certain characteristics concerning members of the group, capabilities or services associated with the user, or other types of information. In addition, the profile may have an associated Quality-of-Service (QoS) level.

High bandwidth applications, such as streaming video or audio applications, are often used in the above-mentioned networks. In these situations, as the amount of bandwidth and the number of network users rises, congestion in the system increases. As congestion increases, it becomes increasingly difficult to provide specified QoS levels to the network users and services.

In previous systems, QoS levels were selected by using various approaches. For instance, in some previous systems, the services dictated their own corresponding QoS requirements, while in other previous systems, the QoS level remained fixed for a given network or type of service.

Unfortunately, all of the previous approaches did not consider the operational differences between the individual users of the system. For example, a particular user might have particular temporal and geographic usage patterns, but would still be assigned the same QoS level that other users were assigned, despite the fact that the other users had very different usage patterns and operating requirements. Consequently, previous systems often supplied uneven QoS levels to users and services leading to inefficient network operations, system delay, dropped communications, and user frustration with the system.

### BRIEF DESCRIPTION OF THE DRAWINGS

FIG. 1 is a block diagram of a system for determining a profile for a group and dynamically modifying the profile according to various embodiments of the present invention;

FIG. 2 is a flowchart of an approach for determining and modifying a group profile according to various embodiments of the present invention;

FIG. 3 is a block diagram of a device for determining and modifying a group profile according to various embodiments of the present invention; and

FIG. 4 is a block diagram of a group profile with multiple QoS levels according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF EMBODIMENTS

A system and method for determining and dynamically modifying a group profile associates a Quality-of-Service (QoS) level to the group profile. The QoS level may be dynamically determined by the usage patterns of members of the group. Consequently, since the QoS level is related to the usage patterns of the group members, more efficient system operation and better service for system users is provided.

In many of these embodiments, a profile for a group having a group member is established. A usage pattern is then determined for the member of the group. The usage pattern may relate to any number of usage conditions. For instance, the usage pattern may be a temporal usage pattern of the user or a geographic usage pattern of the user. Other examples of usage patterns are possible.

A Quality-of-Service (QoS) level is determined for the group and is based upon the determined usage pattern. The QoS level is dynamically modified based upon changes in the usage pattern of the member. In addition, the QoS level may be used for other purposes. For instance, communications made throughout the network may be processed and managed based upon the QoS level.

The QoS level may also be structured in different ways. For example, the QoS level may actually be a plurality of QoS levels. In addition, the QoS level may be based upon the type of device associated with the user.

Dynamic adjustments of the QoS level are possible. For instance, another member of the group may be allowed to directly adjust the QoS level. In addition, the QoS level may be dynamically adjusted as various factors or conditions change over time. For example, the QoS level may change as the number of users in the system change.

In some of these embodiments, an operator may query the profile of the group to determine whether the profile has a predetermined characteristic. The group profile may also be transferred among distinct service areas in the network.

Thus, approaches are described that determine and dynamically modify a group profile and associate a QoS level to the group profile. The QoS level may be determined by the usage patterns of members of the group. Consequently, more balanced QoS levels are provided to system users ensuring more efficient system performance.

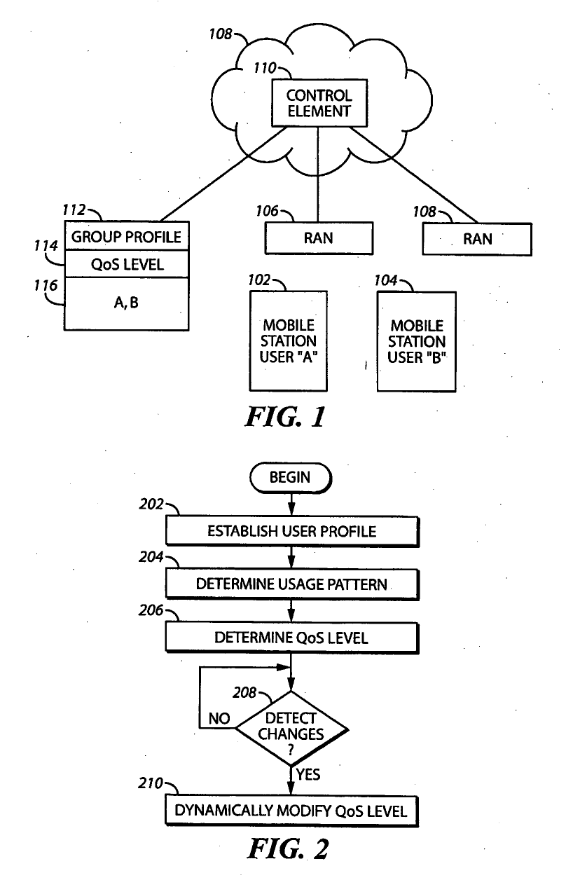

Referring now to FIG. 1, one example of a system that determines a profile for members of a group and that dynamically modifies the profile is described. Mobile stations 102 and 104 operate within a network 109. The mobile stations 102 and 104 may be any type of wireless devices, for instance, cellular telephones, pagers, personal digital assistants (PDAs), or personal computers. Other examples of mobile stations are possible.

The mobile stations 102 and 104 communicate with a first Radio Access Network 106. This RAN 106 and a second RAN 108 include elements that allow the mobile stations 102 and 104 to exchange information with the network 109. In this regard, the RANs 106 and 108 may include base stations, base station controllers, servers, gateways, and other elements that allow the mobile stations 102 and 104 to communicate with the network 109.

The network 109 may be any type of network or any combination of networks. For example, the network 109 may be a packet data network, any wireless network, the Internet, a cellular network, a Push-to-Talk (PTT) network, or a conventional telephone network. As shown, the network 109 includes a control element 110. The control element 110 may be any type of element such as a server. Alternatively, the control element 110 may be located in any of the RANs 106 or 108 or shared between the RANs 106 and 108.

The control element 110 accesses a group profile 112. The members associated with the group profile 112 may be related in particular ways, such as being family members, friends, workgroup members, or public safety workers. The group profile 112 includes a QoS level 114. The group profile 112 also has a field 116 indicating the identities of members of the group. In this example, the field 116 indicates that the members of the group are “A” (associated with the mobile station 102) and “B” (associated with the mobile station 104). The group profile 112 is transferable as a mobile station moves among networks or portions of networks.

The group profile 112 can also include an admissions policy, admission priority, and approaches to improve or give priority. For example, admission to groups may be denied due to device type or behavior of potential members.

QoS levels may be based upon various factors such as the number of users that are joined to a particular profile. For instance, when only two members are associated with a group, a low QoS may be selected. When seven members are associated with the group, a medium QoS may be selected. When 15 members become associated with the group, a high QoS may be selected. Consequently, the higher the number of members assigned to the group, the higher the QoS level. In another example, the QoS can be allocated and/or adjusted according to both fixed and temporal considerations in certain situations. For instance, when it becomes apparent that various groups of users (e.g., fire fighters or police officers) are joining together in a group because of an emergency, the QoS level can be increased.

In one example of the operation of the system of FIG. 1, the profile 112 for a group is established and the group includes members “A” and “B”. A usage pattern is determined for the members of the group. For instance, it may be a temporal usage pattern associated with the users “A” and “B” (e.g., when these users are using the system). In another example, the usage pattern may be a geographic usage pattern of where the users are using the system (e.g., along certain highways or in certain cities or areas of cities). Other examples of usage conditions are possible. In still another example, the QoS level may depend upon the type of device used by the user.

The QoS level 114 is determined for the group and is based upon the determined usage pattern. For instance, a high QoS level may be associated with certain geographical locations (e.g., the user is in their vehicle and on their way to work) and certain time periods (e.g., 7:00-9:00 a.m. and 4:00-6:00 p.m.) during the day. Other locations and time periods would receive low or medium QoS levels.

The QoS level 114 may be dynamically modified based upon changes in the usage pattern of the member. For instance, as the geographic usage patterns of the users change, the QoS level 114 may be adjusted accordingly. In another example, as the number of system users change, the QoS level 114 may be adjusted.

In addition, the QoS level 114 may be used for other purposes. For instance, communications made throughout the network may be processed and managed based upon the QoS level 114. Specifically, communications may be prioritized for processing according to the QoS level 114.

The QoS level 114 may be a plurality of QoS levels. For instance, each user within the group may have a separate QoS level. In another example, certain types of communications may receive different QoS levels. In still another example, different categories of users (e.g., teenage students, parents, and teachers) may be grouped together for a certain event, but each of these sub-groups may have a different QoS level.

In another approach, a predefined group (e.g., family or friends) is collectively credited with a certain amount of QoS units. Then, within a group profile, there is a predefined distribution of these QoS credits among members. If one or more of the group members are not connected at any given point in time, their credits are redistributed to the others.

Certain members of the group may be allowed to adjust the QoS level 114. For example, users at the mobile stations 102 and 104 may be allowed under certain circumstances (e.g., payment of higher fees) to change the QoS level 114 (or any sub-level) associated with the group. In another example, the highest priority user within a group may have the capability of lowering the QoS level 114 for a certain time period and can give a higher QoS level 114 to another group member for the same or a different time period.

An operator within the network 109 may query the profile of the group to determine whether the profile 112 has a predetermined characteristic. For instance, group profiles may be queried for the QoS and adjusted based upon the need at times of heavy usage. Specifically, the QoS query may be made to determine if the group exists (e.g., a member is out of town) or the profile is no longer in use (e.g., the member has moved). The group profile may also be transferred among distinct service areas in the network 109.

Referring now to FIG. 2, one approach for dynamically determining and adjusting a group profile is described. At step 202 a profile for a group of users is established. The group comprises at least one member. The profile includes a Quality of Service (QoS) level or multiple QoS levels that are associated with members of the group.

At step 204, a usage pattern is determined for the member of the group. The system may use various functional entities (e.g., base stations, servers) to determine the geographic usage patterns of users. For instance, the system may determine the cities, highways, airports, or the countries where they operate. In another example, the system may determine the temporal usage patterns of users within the system. Specifically, the system may determine the times of day when the users are communicating. In still another example, the usage patterns may include both temporal and geographic considerations, for example, the highways where the user is employing their mobile station and the times of day when this occurs.

At step 206, the QoS level is determined and this level is associated to the group based upon the usage pattern of the member of the group. In one example, if the user is using the network at a high-traffic volume time of day, a high QoS level may be assigned. On the other hand, if the user is using the network during a low traffic time period, then a relatively low QoS level may be assigned.

Other types of considerations may also affect the determination of the QoS level. For example, the type of equipment employed by the user and the level of services paid for the user may also affect the QoS level that is selected.

At step 208, it is determined if changes have been determined in the usage pattern of a user. If the answer is affirmative, at step 208, the QoS level is dynamically modified based upon changes in the usage pattern of the at least one member of the group.

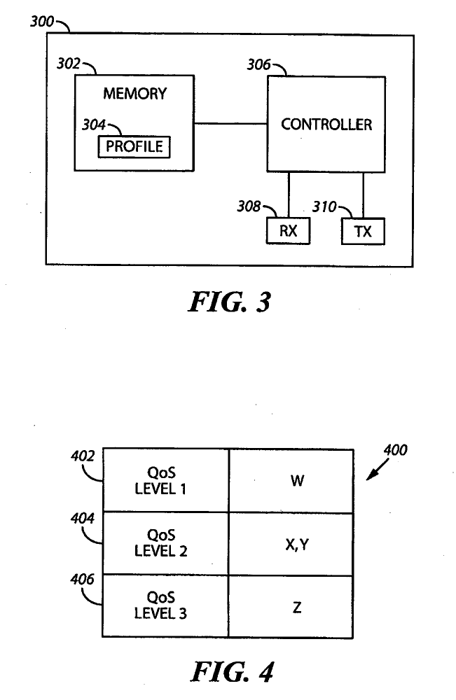

Referring now to FIG. 3, one example of a device for determining a profile of a group and dynamically adjusting the profile is described. The device includes a memory 302 (including a group profile 304), a controller 306, a receiver 308, and a transmitter 310.

The transmitter 310 may send information to other system elements that use the information in the memory 302. The controller 306 receives a usage pattern for the member of the group at the input of the receiver 308. The controller 306 is programmed to determine and associate a QoS level with the profile 304 of the group based upon the usage pattern. The controller 306 is further programmed to store the QoS level in the memory 302 and to dynamically modify the QoS level based upon changes in the usage pattern of the at least one member of the group.

Referring now to FIG. 4, one example of a group profile having multiple QoS levels is described. In this example, the group profile 400 includes multiple QoS levels 402, 404, and 406. Each of these QoS levels is associated with different members of the group. For example, in a network having four members “W”, “X”, “Y”, and “Z”, level 402 may be associated with “W”, 404 with “X” and “Y,” and 406 with “Z.”

The QoS levels may range from high relative values to lower values and the assignment of a particular user to a particular level may be based upon any number of factors. For example, the assignment of a user to a particular level may be based upon the geographic or temporal operating patterns of a particular user. In another example, the assignment may be based upon the level of service paid for by the user or the type of equipment utilized by the user. In still another example, the assignment of some levels may be determined based upon some factors, while assignment of other levels may be based upon other factors.

The QoS levels 402, 404 and 406 may also be dynamically adjusted over time and this adjustment may be based upon different considerations. For example, the number of users of the system may be determined and periodically, based upon this determination, the QoS levels 402, 404, and 406 may be raised or lowered.

Thus, approaches are described that determine and dynamically modify a group profile and associate a QoS level to the group profile. The level may determined by the usage patterns of members of the group. The approaches described herein provide QoS levels to members of a group that are more balanced than those associated with previous systems ensuring more efficient system operation and better service quality for system users.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of determining a Quality-of-Service (QoS) level for members of a group comprising:
establishing a profile for a group, the group comprising at least one member;
determining a usage pattern for the at least one member of the group;
determining and associating a Quality-of-Service (QoS) level to the group based upon the usage pattern of the at least one member of the group; and
dynamically modifying the QoS level based upon changes in the usage pattern of the at least one member of the group.

2. The method of claim 1 wherein determining a usage pattern comprises determining at least one usage pattern selected from a group comprising: a temporal usage pattern and a geographic usage pattern.

3. The method of claim 1 further comprising managing communications in a network based at least in part upon the QoS level.

4. The method of claim 1 wherein determining the QoS level comprises determining a plurality of QoS levels.

5. The method of claim 1 wherein determining the QoS level comprises determining the QoS level based at least in part upon a type of device.

6. The method of claim 1 further comprising at an operator, querying the profile to determine whether the profile has a predetermined characteristic.

7. The method of claim 1 further comprising transferring the profile among distinct service areas in a network.

8. The method of claim 1 further comprising allowing another member of the group to adjust the QoS level.

9. The method of claim 1 wherein dynamically adjusting the QoS comprises dynamically adjusting the QoS based upon a number of users.

10. A method of determining a Quality-of-Service (QoS) level for members of a group comprising:
determining temporal and geographic usage patterns for at least one member of a group; and
determining and associating a Quality-of-Service (QoS) level to the group based upon the temporal and geographic usage patterns of the at least one member of the group.

11. The method of claim 10 further comprising dynamically modifying the QoS level based upon changes in the temporal and geographic usage patterns of the at least one member of the group.

12. The method of claim 10 further comprising managing communications in a network based at least in part upon the QoS level.

13. The method of claim 10 wherein determining the QoS level comprises determining a plurality of QoS levels.

14. A device for determining the Quality-of-Service (QoS) for members of a group comprising:
a memory having a profile for a group stored therein, the group comprising at least one member;
a receiver having an input; and
a controller coupled to the memory and the receiver, the controller receiving a usage pattern for the at least one member of the group at the input of the receiver, the controller being programmed to determine and associate a QoS level to the profile of the group based upon the usage pattern, the controller being further programmed to store the QoS level in the memory, the controller being further programmed to dynamically modify the QoS level based upon changes in the usage pattern of the at least one member of the group.

15. The device of claim 14 wherein the usage pattern is selected from a group comprising: a temporal usage pattern and a geographic usage pattern.

16. The device of claim 14 wherein the controller is programmed to determine a plurality of QoS levels.

17. The device of claim 14 wherein the controller is programmed to determine the QoS level based at least in part upon a type of device.
